(19) United States
(12) Patent Application Publication
(10) Pub. No.: US 2006/0276184 A1
(43) Pub. Date: Dec. 7, 2006

(54) Method and system for in-vehicle messaging management

(75) Inventors: Laurence J. Tretyak, Highland, MI (US); Mingheng Wang, Rochester Hills, MI (US); Gary A. Watkins, Royal Oak, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/142,715

(22) Filed: Jun. 1, 2005

(51) Int. Cl. H04M 3/00

(52) U.S. Cl. 455/418; 455/456.1

(57) ABSTRACT

A method for managing an in-vehicle messaging service in a vehicle corresponding to a subscriber of the in-vehicle messaging service. The method involves a storage of an alert message notification pushed to the vehicle, wherein the alert message notification includes information representative of a presentation period of the alert message notification, and an automatic presentation of the stored alert message notification within the vehicle based on a start of the presentation period.

### FIELD OF THE INVENTION

The present invention generally relates to an in-vehicle messaging service.

### BACKGROUND OF THE INVENTION

Inclusion of wireless communication systems within mobile vehicles provides an opportunity to communicate between the vehicle and a central location. For example, an operator of such a vehicle may subscribe to an in-vehicle messaging service that enables the subscriber to pull desired information from the central location via a wireless connection.

Wireless communication can include cellular connections, as well as short-range wireless connections such as an 802.11 connection. In order to pull the desired information from the central location, the communication is typically either triggered by a direct user request, or automatically as a result of an occurrence of a trigger event. However, this can result in unnecessary communication attempts with the central location. In addition to wireless communication capacity, many vehicles are also equipped with GPS equipment to determine a location of the vehicle, and location-based triggers for pulling the desired information from the central location, but may also result in unnecessary communication attempts with the central location.

The present invention overcomes these disadvantages and advances the state of the art in-vehicle message servicing.

### SUMMARY OF THE INVENTION

One aspect of the present invention provides a method for managing an in-vehicle messaging service in a vehicle corresponding to a subscriber of the in-vehicle messaging service. The method comprises a storage of an alert message notification pushed to the vehicle, wherein the alert message notification includes information representative of a presentation period of the alert message notification, and an automatic presentation of the stored alert message notification within the vehicle based on a start of the presentation period.

Another aspect of the invention provides a computer readable medium for managing an in-vehicle messaging service in a vehicle corresponding to a subscriber of the in-vehicle messaging service. The computer readable medium comprises computer readable code for storing an alert message notification pushed to the vehicle, wherein the alert message notification includes information representative of a presentation period of the alert message notification, and computer readable code for automatically presenting the stored alert message notification within the vehicle based on a start of the presentation period.

Another aspect of the invention provides a system for managing an in-vehicle messaging service in a vehicle corresponding to a subscriber of the in-vehicle messaging service. The system comprises means for storing an alert message notification pushed to the vehicle, wherein the alert message notification includes information representative of a presentation period of the alert message notification, and means for automatically presenting the stored alert message notification within the vehicle based on a start of the presentation period.

The aforementioned and other features and advantages of the invention will become further apparent from the following detailed description of the presently preferred embodiments, read in conjunction with the accompanying drawings. The detailed description and drawings are merely illustrative of the invention rather than limiting the scope of the invention being defined by the appended claims and equivalents thereof.

### BRIEF DESCRIPTION OF THE DRAWINGS

FIG. 1 illustrates an operating environment for a method for establishing communication with a mobile vehicle; and

FIG. 2 illustrates a first embodiment of a method for managing an in-vehicle messaging service in accordance with the present invention;

FIG. 3 illustrates a first embodiment of an alert message notification in accordance with the present invention;

FIG. 4 illustrates a first embodiment of an alert header data field in accordance with the present invention;

FIG. 5 illustrates a second embodiment of a method for managing an in-vehicle messaging service in accordance with the present invention;

FIG. 6 illustrates a second embodiment of an alert message notification in accordance with the present invention; and

FIG. 7 illustrates a second embodiment of an alert header data field in accordance with the present invention.

### DETAILED DESCRIPTION OF THE PREFERRED EMBODIMENTS

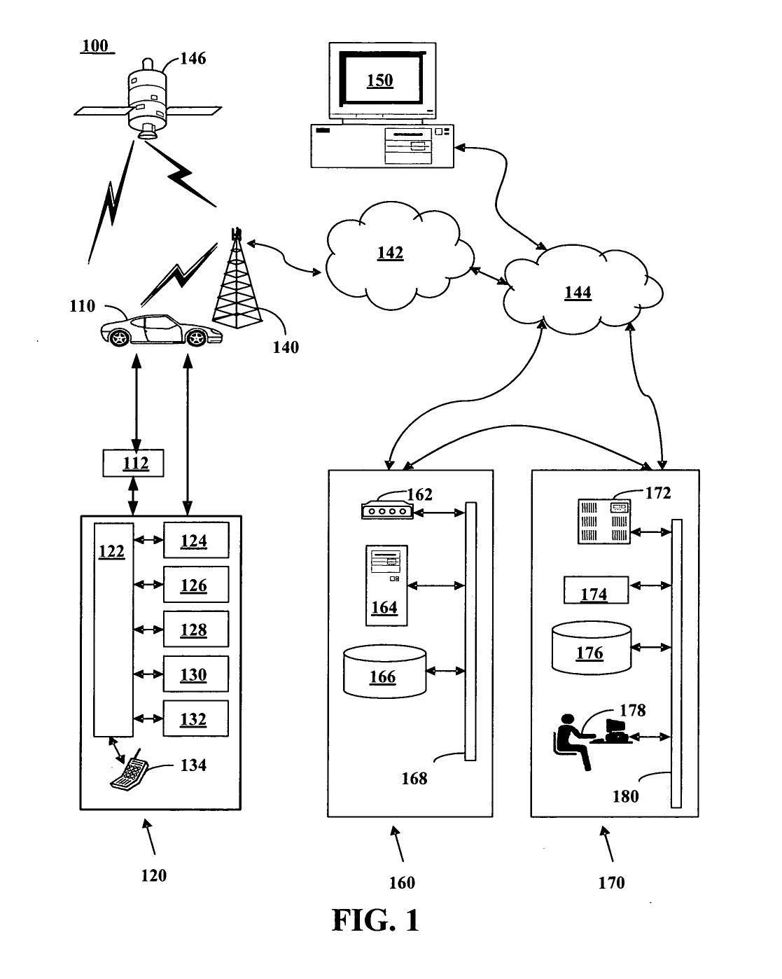

FIG. 1 illustrates an operating environment for a mobile vehicle communication system (“MVCS”) 100 for navigation. MVCS 100 includes a mobile vehicle communication unit (“MVCU”) 110, a vehicle communication network 112, a telematics unit 120, one or more wireless carrier systems 140, one or more communication networks 142, one or more land networks 144, one or more satellite broadcast systems 146, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 is also referred to as a mobile vehicle in the discussion below. In operation, MVCU 110 may be implemented as a motor vehicle, marine vehicle or as an aircraft. MVCU 110 may include additional components not relevant to the present discussion.

Vehicle communication network 112, sends signals to various units of equipment and systems within vehicle 110 to perform various functions such as monitoring the operational state of vehicle systems, collecting and storing data from the vehicle systems, providing instructions, data and programs to various vehicle systems, and calling from telematics unit 120. In facilitating interactions among the various communication and electronic modules, vehicle communication network 112 utilizes interfaces such as controller-area network (CAN), Media Oriented System Transport (MOST), Local Interconnect Network (LIN), Ethernet (10 base T, 100 base T), International Organization for Standardization (ISO) Standard 9141, ISO Standard 11898 for high-speed applications, ISO Standard 11519 for lower speed applications, and Society of Automotive Engineers (SAE) standard J1850 for higher and lower speed applications. In one embodiment, vehicle communication network 112 is a direct connection between connected devices.

Telematics unit 120 sends to and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (“GPS”) unit 126, an in-vehicle memory 128, a microphone 130, one or more speakers 132, and an embedded or in-vehicle mobile phone 134. In other embodiments, telematics unit 120 may be implemented without one or more of the above listed components such as, for example, speakers 132. Telematics unit 120 may include additional components not relevant to the present discussion. Telematics unit 120 is one example of a vehicle module.

In one embodiment, processor 122 is implemented as a microcontroller, controller, host processor, or vehicle communications processor. In one embodiment, processor 122 is a digital signal processor. In an example, processor 122 is implemented as an application specific integrated circuit. In another embodiment, processor 122 is implemented as a processor working in conjunction with a central processing unit performing the function of a general purpose processor. GPS unit 126 provides longitude and latitude coordinates of the vehicle responsive to a GPS broadcast signal received from one or more GPS satellite broadcast systems (not shown). In-vehicle mobile phone 134 is a cellular-type phone such as, for example, a digital, dual-mode (e.g., analog and digital), dual-band, multi-mode, or multi-band cellular phone.

Processor 122 executes various computer programs that control programming and operational modes of electronic and mechanical systems within MVCU 110. Processor 122 controls communication (e.g., call signals) between telematics unit 120, wireless carrier system 140, and call center 170. Additionally, processor 122 controls reception of communications from satellite broadcast system 146. In one embodiment, a voice-recognition application is installed in processor 122 that can translate human voice input through microphone 130 to digital signals. Processor 122 generates and accepts digital signals transmitted between telematics unit 120 and vehicle communication network 112 that is connected to various electronic modules in the vehicle. In one embodiment, these digital signals activate the programming mode and operation modes, as well as provide data transfers such as, for example, data over voice channel communication. In this embodiment, signals from processor 122 are translated into voice messages and sent out through speaker 132.

Wireless carrier system 140 is a wireless communications carrier or a mobile telephone system and transmits to and receives signals from one or more MVCU 110. Wireless carrier system 140 incorporates any type of telecommunications in which electromagnetic waves carry signal over part of or the entire communication path. In one embodiment, wireless carrier system 140 is implemented as any type of broadcast communication in addition to satellite broadcast system 146. In another embodiment, wireless carrier system 140 provides broadcast communication to satellite broadcast system 146 for download to MVCU 110. In an example, wireless carrier system 140 connects communication network 142 to land network 144 directly. In another example, wireless carrier system 140 connects communication network 142 to land network 144 indirectly via satellite broadcast system 146.

Satellite broadcast system 146 transmits radio signals to telematics unit 120 within MVCU 110. In one embodiment, satellite broadcast system 146 may broadcast over a spectrum in the “S” band of 2.3 GHz that has been allocated by the U.S. Federal Communications Commission for nationwide broadcasting of satellite-based Digital Audio Radio Service.

In operation, broadcast services provided by satellite broadcast system 146 are received by telematics unit 120 located within MVCU 110. In one embodiment, broadcast services include various formatted programs based on a package subscription obtained by the user and managed by telematics unit 120. In another embodiment, broadcast services include various formatted data packets based on a package subscription obtained by the user and managed by call center 170. In an example, processor 122 implements data packets received by telematics unit 120.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network. In another embodiment, land network 144 is implemented as an Internet Protocol (“IP”) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal, or user computer 150 includes a computer usable medium to execute Internet browsers and Internet-access computer programs for sending and receiving data over land network 144 and, optionally, wired or wireless communication networks 142 to web-hosting portal 160 through a web-page interface using communication standards such as hypertext transport protocol, and transport-control protocol and Internet protocol. In one embodiment, the data include directives to change certain programming and operational modes of electronic and mechanical systems within MVCU 110.

In operation, a client utilizes computer 150 to initiate setting or re-setting of user preferences for MVCU 110. In an example, a client utilizes computer 150 to provide radio station presets as user preferences for MVCU 110. User-preference data from client-side software is transmitted to server-side software of web-hosting portal 160. In an example, user-preference data are stored at web-hosting portal 160.

Web-hosting portal 160 includes one or more data modems 162, one or more web-servers 164, one or more databases 166, and a network system 168. Web-hosting portal 160 is connected directly by wire to call center 170, or connected by phone lines to land network 144, which is connected to call center 170. In an example, web-hosting portal 160 connects to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and receives digital data from modem 162, data that are then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web server 164 hosting portal 160 through a wireless communication network 142 and a land network 144. Data are received by land network 144 and sent to one or more web servers 164. In one embodiment, web server 164 is implemented as any suitable hardware and software capable of providing web server 164 services to help change and transmit personal preference settings from a client at computer 150 to telematics unit 120. Web server 164 sends to or receives from one or more databases 166 data transmissions via network system 168. Web server 164 includes computer applications and files for managing and storing personalized settings supplied by the client, such as door lock/unlock behavior, radio station preset selections, climate controls, custom button configurations, and theft alarm settings. For each client, the web server 164 potentially stores hundreds of preferences for wireless vehicle communication, networking, maintenance and diagnostic services for a mobile vehicle. In another embodiment, web server 164 further includes data for managing turn-by-turn navigational instructions.

In one embodiment, one or more web servers 164 are networked via network system 168 to distribute user-preference data among its network components such as databases 166. In an example, database 166 is a part of or a separate computer from web server 164. Web server 164 sends data transmission with user preferences to call center 170 through land network 144.

Call center 170 is a location where many calls are received and serviced at the same time, or where many calls are sent at the same time. In one embodiment, the call center is a telematics call center facilitating communications to and from telematics unit 120. In another embodiment, the call center is a voice call center, providing verbal communications between an advisor in the call center and a subscriber in a mobile vehicle. In yet another embodiment, the call center contains each of these functions. In other embodiments, call center 170 and web server 164 and hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web server 164 and hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmission via network system 180. For example, communication services manager 174 may include at least one digital and/or analog modem.

Communication services manager 174 sends to or receives from one or more communication services advisors 178 data transmission via network system 180. Communication services database 176 sends or receives from communication services advisor 178 data transmissions via network system 180. Communication services advisor 178 receives from or sends to switch 172 voice or data transmissions. Communication services manager 174 provides one or more of a variety of services including initiating data over voice channel wireless communication, enrollment services, navigation assistance, directory assistance, roadside assistance, business or residential assistance, information services assistance, emergency assistance, and communications assistance.

Communication services manager 174 receives service-preference requests for a variety of services from the client computer 150, web server 164, hosting portal 160, and land network 144. Communication services manager 174 transmits user-preference and other data such as, for example, primary diagnostic script to telematics unit 120 through wireless carrier system 140, communication network 142, land network 144, voice and data switch 172, and network system 180. Communication services manager 174 stores or retrieves data and information from communication services database 176. Communication services manager 174 may provide requested information to communication services advisor 178. In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, automated vehicle diagnostic function, and communications assistance. Communication services advisor 178 communicates with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

In operation, an incoming call is routed to a telematics unit 120 within mobile vehicle 110 from call center 170. In one embodiment, the call is routed to telematics unit 120 from call center 170 via land network 144, communication network 142, and wireless carrier system 140. In another embodiment, an outbound communication is routed to telematics unit 120 from call center 170 via land network 144, communication network 142, wireless carrier system 140, and satellite broadcast system 146. In this embodiment, an inbound communication is routed to call center 170 from telematics unit 120 via wireless carrier system 140, communication network 142, and land network 144.

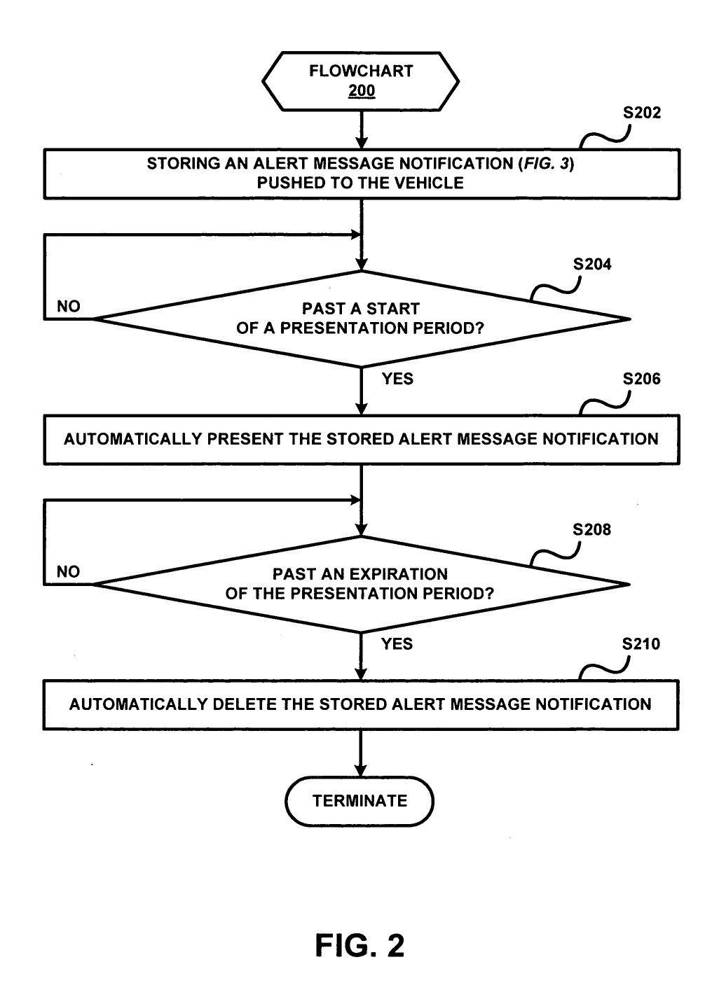

FIG. 2 illustrates a flowchart 200 representative of an in-vehicle messaging management method of the present invention. Referring to FIG. 2, flowchart 200 is executed by a telematics unit (e.g., telematics unit 120 shown in FIG. 1). A stage S202 of flowchart 200 encompasses the telematics unit storing an alert message notification pushed to a vehicle housing the telematics unit (e.g., MVCU 110 shown in FIG. 1) and corresponding to a subscriber of an in-vehicle messaging service. The alert message notification includes many forms of information necessary to timely alert the occupant(s) of the vehicle to an alert message. In one embodiment, the alert message notification includes information representative of a presentation period for presenting the alert message notification to the occupant(s) of the vehicle from a specific start time to a specific expiration time. The alert message notification can further include the alert message or alternatively, information representative of a unique identification of the alert message to thereby facilitate a downloading an alert message associated with the alert message notification based on the unique identification of the alert message notification. One or more phone numbers may also be included within the notification to enable the occupant(s) of the vehicle to obtain additional information related to the alert message (e.g., call center phone number and a police station phone number).

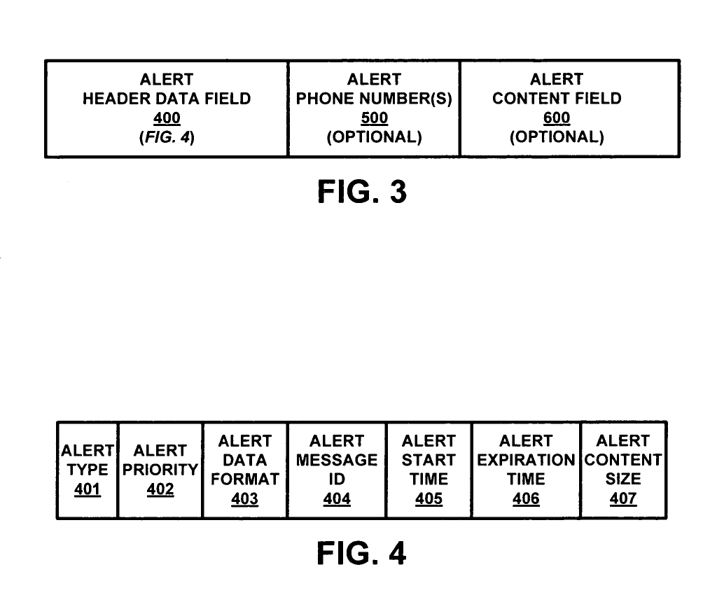

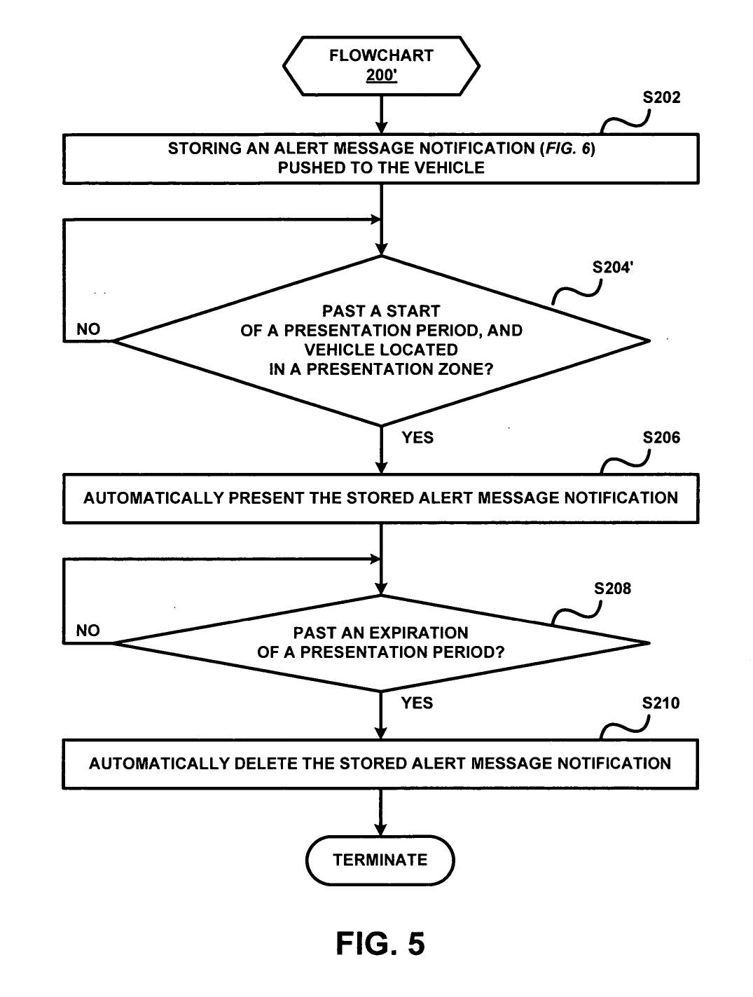

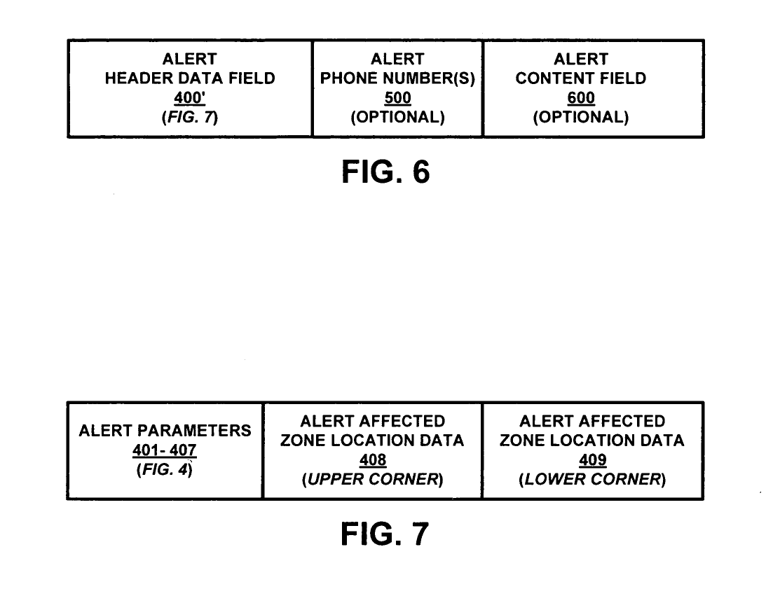

FIG. 3 illustrates one embodiment of the alert message notification suitable for flowchart 200, the alert message notification including an alert header data field 400, an optional alert phone number 500 and an optional alert content field 600. Alert header data field 400 is a time sensitive field that may including parameters 401-407 as shown in FIG. 4 and explained in the following table:

| Parameter | Parameter Description |
|---|---|
| Alert Type 401 | 1. Disaster |
| | 2. Amber |
| | 3. Traffic |
| | 4. Weather |
| | 5. Generic |
| | 6. Campaign |
| | 7. Reminder |
| | 8. Reserved1 |
| Alert Priority 402 | 1. High |
| | 2. Medium |
| | 3. Low |
| Alert Data Format 403 | 1. Text |
| | 2. Audio in AMR Mode 1 - 5.15 Kbps |
| | 3. Audio in WMA |
| | 4. Audio in AAC |
| | 5. Graphic |
| | 6. Video in JPEG2 |
| Alert Message ID 404 | Unique ID assigned by call center 170 |
| | (FIG. 1) |
| Alert Start Time (UTC) 405 | Date/Time (e.g., Jan. 1, 2004, 09:00:00) |
| Alert Expiration Time | Date/Time (e.g., Jan. 2, 2004, 09:00:00) |
| (UTC) 406 | |
| Alert Content Size 407 | Number of total bytes for the alert message |
| (Optional) | contained in optional field 600 |

Alert phone number 500 enables one to initiate a call via a voice command to call center 170 or a third party for additional information related to the alert message, and alert content field 500 contains the alert message in binary form.

Referring again to FIG. 2, a stage S204 of flowchart 200 encompasses the telematics unit determining whether the presentation period has started. In one embodiment, the telematics unit determines the presentation period has started when the alert start time parameter 405 is in the past. If the telematics unit determined during stage S204 that the presentation period has started, then the telematics unit proceeds to a stage S206 of flowchart 200 to automatically present the stored alert message notification. In one embodiment, the telematics unit presents the alert message notification in voice within the vehicle with little or no delay after receiving the alert message notification if the vehicle ignition is on at the time the alert message notification is received by the telematics unit, or presents the alert message notification in voice within the vehicle subsequent to the first time the vehicle ignition is switched on after the alert message notification has been received by the telematics unit. Occupant(s) of the vehicle can therefore hear the alert message if alert content field 600 is included within the alert message notification, or hear and see the alert message ID parameter 404 to thereby download the alert message to the vehicle if alert content field 600 is excluded from the alert message notification.

A stage S208 of flowchart 200 encompasses the telematics unit determining whether the presentation period has expired. In one embodiment, the telematics unit determines the presentation period has expired when the alert expiration time parameter 406 is in the past. If the telematics unit determined during stage S208 that the presentation period has expired, then the telematics unit proceeds to a stage S210 of flowchart 200 to automatically delete the stored alert message notification from the vehicle.

FIG. 5 illustrates a flowchart 200′ representative of an in-vehicle messaging management method of the present invention. Referring to FIG. 5, flowchart 200′ is a modified version of flowchart 200 (FIG. 2) suitable for an alert message notification including many forms of information necessary to timely and precisely alert the occupant(s) of the vehicle to an alert message. In one embodiment, the alert message notification includes information representative of a presentation period and a presentation zone for presenting the alert message notification to the occupant(s) of the vehicle within a specific geographic zone from a specific start time to a specific expiration time. The alert message notification can further include the alert message or alternatively, information representative of a unique identification of the alert message to thereby facilitate a downloading an alert message associated with the alert message notification based on the unique identification of the alert message notification. A phone number may also be included within the notification to enable one to obtain additional information related to the alert message.

FIG. 6 illustrates one embodiment of the alert message notification suitable for flowchart 200′, the alert message notification including an alert header data field 400′, an optional alert phone number 500 and an optional alert content field 600. Alert header data field 400′ is a time sensitive field that may include parameters 401-407 as shown in FIG. 7 and parameters 408 and 409 explained in the following table:

| | |
|---|---|
| Alert affected zone location | Latitude and longitude data in radian |
| data 408 - left upper corner | format for disaster rectangular zone |
| | location 1. |
| Alert affected zone location | Latitude and longitude data in radian |
| data 409 - right lower corner | format for disaster rectangular zone |
| | location 2. |

Referring to FIG. 5, a stage 204′ is substituted for stage S204 (FIG. 2). Stage S204′ encompasses the telematics unit determining whether the presentation period has started and whether the vehicle is in the presentation zone. In one embodiment, the telematics unit determines the presentation period has started when the alert start time parameter 405 is in the past and determines the vehicle is in the presentation zone when a GPS signal indicates the vehicle is located within a geographic region having a rectangular shape defined by left upper corner 408 and right lower corner parameter 409. If the telematics unit determines during stage S204′ that the presentation period has started and the vehicle is located in the presentation zone, then the telematics unit proceeds to stage S206-S210 as previously described herein in connection with FIG. 2.

Those having ordinary skill in the art will appreciate the numerous and varied advantages and benefits of the present invention from the description herein of FIGS. 2-7.

The present invention may be embodied in other specific forms without departing from the spirit or essential characteristics. The described embodiments are to be considered in all respects only as illustrative and not restrictive.

What is claimed is:

1. A method for managing an in-vehicle messaging service in a vehicle corresponding to a subscriber of the in-vehicle messaging service, the method comprising:
storing an alert message notification pushed to the vehicle, wherein the alert message notification includes information representative of a presentation period of the alert message notification; and
automatically presenting the stored alert message notification within the vehicle based on a start of the presentation period.

2. The method of claim 1, wherein the alert message notification includes an alert header data field having an alert start time parameter indicative of the start of the presentation period.

3. The method of claim 1, further comprising:
automatically deleting the stored alert message notification from the vehicle based on an expiration of the presentation period.

4. The method of claim 3, wherein the alert message notification includes an alert header data field having an alert start time parameter indicative of the start of the presentation period and an alert expiration time parameter indicative of the expiration of the presentation period.

5. The method of claim 1,
wherein the alert message notification further includes information representative of a presentation zone of the alert message notification; and
wherein automatically presenting the alert message notification within the vehicle is further based on the vehicle being located in the presentation zone.

6. The method of claim 5, wherein the alert message notification includes an alert header data field having an alert affected zone location data parameter indicative of the presentation zone of the alert message notification.

7. The method of claim 1, wherein the alert message notification includes an alert content field having an alert content parameter indicative of an alert message.

8. The method of claim 1, further comprising:
downloading an alert message associated with the alert message notification based on an unique identification of the alert message notification, wherein the alert message notification further includes information representative of the unique identification of the alert content parameter.

9. The method of claim 8, wherein the alert message notification includes an alert header data field having an alert message identification parameter indicative of the unique identification of the alert message notification.

10. The method of claim 1, wherein the includes a phone number parameter indicative of a phone number for obtaining additional information related to the alert notification parameter.

11. A computer usable medium for managing an in-vehicle messaging service in a vehicle corresponding to a subscriber of the in-vehicle messaging service, the computer usable medium comprising:
computer readable code for storing an alert message notification pushed to the vehicle, wherein the alert message notification includes information representative of a presentation period of the alert message notification; and
computer readable code for automatically presenting the stored alert message notification within the vehicle based on a start of the presentation period.

12. The computer usable medium of claim 11, further comprising:
computer readable code for automatically deleting the stored alert message notification from the vehicle based on an expiration of the presentation period.

13. The computer usable medium of claim 11,
wherein the alert message notification further includes information representative of a presentation zone of the alert message notification; and
wherein automatically presenting the alert message notification within the vehicle is further based on the vehicle being located in the presentation zone.

14. The computer usable medium of claim 11, wherein the alert message notification further includes information representative of an alert content.

15. The computer usable medium of claim 11, further comprising;
computer readable code for downloading an alert message associated with the alert message notification based on an unique identification of the alert message notification, wherein the alert message notification further includes information representative of the unique identification of the alert content parameter.

16. A system for managing an in-vehicle messaging service in a vehicle corresponding to a subscriber of the in-vehicle messaging service, the system comprising:
means for storing an alert message notification pushed to the vehicle, wherein the alert message notification includes information representative of a presentation period of the alert message notification; and
means for automatically presenting the stored alert message notification within the vehicle based on a start of the presentation period.

17. The system of claim 16, further comprising:
means for automatically deleting the stored alert message notification from the vehicle based on an expiration of the presentation period.

18. The system of claim 16,
wherein the alert message notification further includes information representative of a presentation zone of the alert message notification; and
wherein automatically presenting the alert message notification within the vehicle is further based on the vehicle being located in the presentation zone.

19. The system of claim 16, wherein the alert message notification further includes information representative of an alert content.

20. The system of claim 16, further comprising;
means for downloading an alert message associated with the alert message notification based on an unique identification of the alert message notification, wherein the alert message notification further includes information representative of the unique identification of the alert content parameter.
